(19) United States
(12) Patent Application Publication
(10) Pub. No.: US 2003/0145521 A1
(43) Pub. Date: Aug. 7, 2003

(54) Fire safety window

(76) Inventors: Tyler Leighton Moersch, Minneapolis, MN (US); Darrel Kenneth Rhea, Redwood City, CA (US); Alex W.K. Tan, Eindhoven (NL); Marko Macura, Eindhoven (NL)

Correspondence Address: MERCHANT & GOULD PC, P.O. BOX 2903, MINNEAPOLIS, MN, 55402-0903, US

(21) Appl. No.: 10/328,369

(22) Filed: Dec. 23, 2002

Related U.S. Application Data
(60) Provisional application No. 60/386,207, filed on Feb. 6, 2002.

(51) Int. Cl. G08B 13/08

(52) U.S. Cl. 49/13

(57) ABSTRACT

A window unit that includes a window frame defining a frame perimeter and a window located within the frame perimeter. Window hardware is disposed on the window. The window hardware has a window hardware illumination element. A frame perimeter illumination element is disposed on the frame perimeter. The window hardware illumination element and frame perimeter illumination element produce an illuminated visual indicator in response to an activating signal.

### RELATED APPLICATIONS

This application claims the benefit of U.S. Ser. No. 10/068,689 filed Feb. 6, 2002, which application was converted to U.S. Provisional Serial No. 60/386,207 filed Feb. 6, 2002.

### BACKGROUND OF THE INVENTION

The invention generally relates to window units that provide egress indicators for escape from a structure during a fire and or smoke event. Egress indicators may include, for example, illumination devices and audio devices, and the like.

In case of a fire in a building, the occupants of a building need to be able to escape, often through the windows of the building. This can be problematical, because windows may be hard to locate in a fire and/or smoky room, and it may be hard to locate the window hardware to unlock and to open the window for egress.

### SUMMARY OF THE INVENTION

In accordance with the present invention, there is provided a window unit that includes a window frame defining a frame perimeter and a window located within the frame perimeter. Window hardware is disposed on the window. The window hardware has a window hardware illumination element. A frame perimeter illumination element is disposed on the frame perimeter. The window hardware illumination element and frame perimeter illumination element produce an illuminated visual indicator in response to an activating signal.

Also in accordance with the present invention, there is provided a method that includes providing a window frame defining a frame perimeter and providing a window within the frame perimeter. The method includes disposing window hardware on the window. The window hardware has a window hardware illumination element. The method further includes disposing a frame perimeter illumination element on the frame perimeter. The window hardware illumination element and frame perimeter illumination element produce an illuminated visual indicator in response to an activating signal.

### BRIEF DESCRIPTION OF THE DRAWINGS

FIG. 1 is a perspective view of a window unit in accordance with the invention.

FIG. 2 is a perspective view of the window unit shown in FIG. 1 responding to an activation signal.

FIG. 3 is a perspective exterior view of a window unit installed in a structure in accordance with the invention.

FIG. 4 is a perspective exterior view of the window unit shown in FIG. 3 responding to an activation signal.

### DETAILED DESCRIPTION OF THE PREFERRED EMBODIMENT

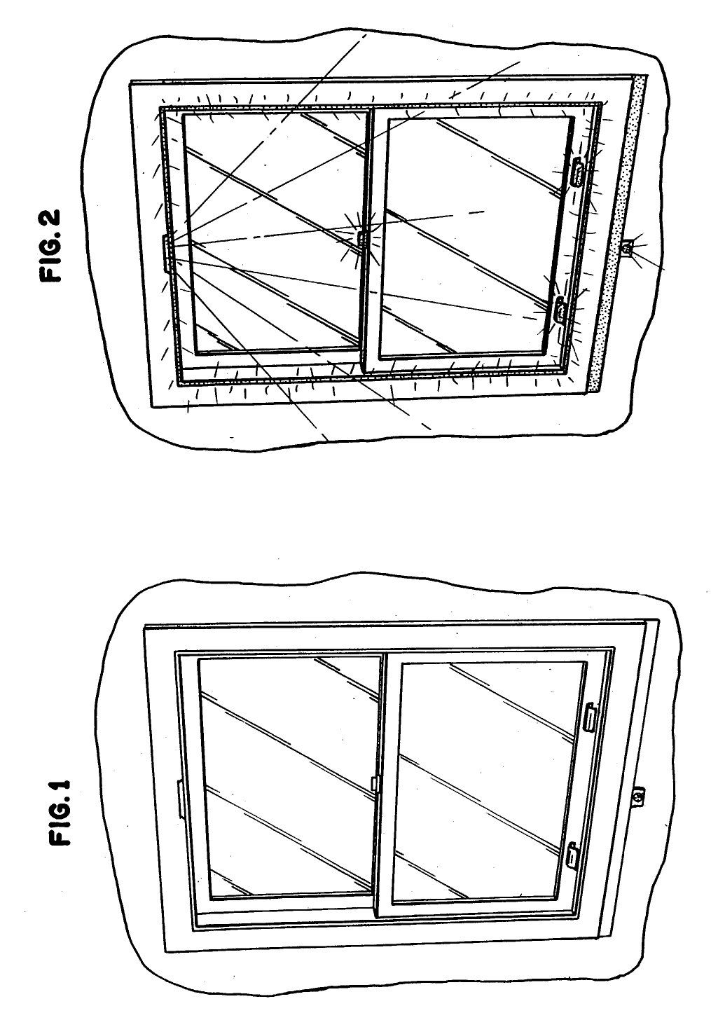

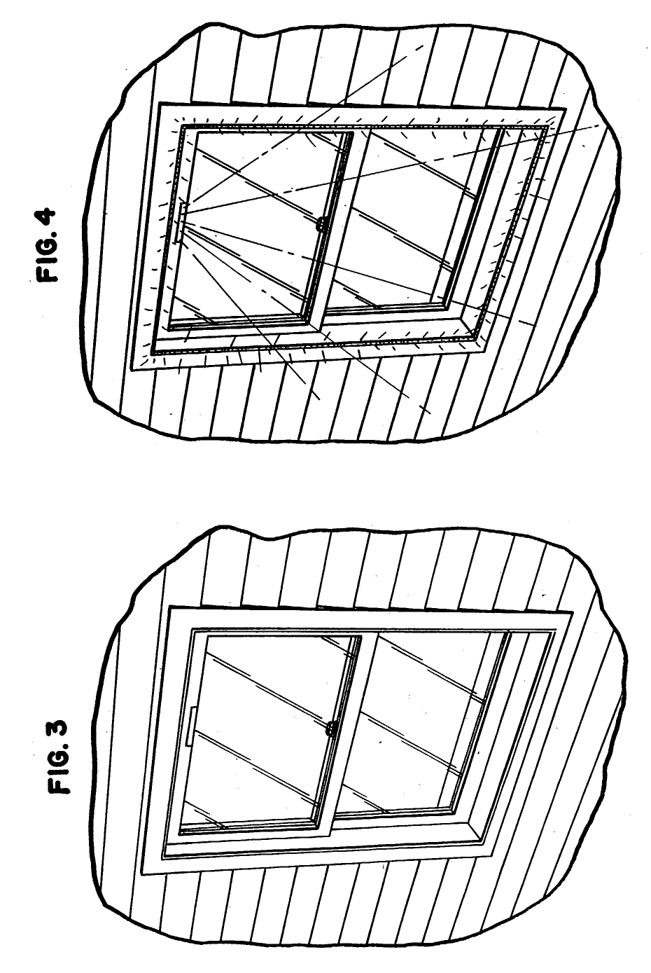

FIG. 1 is a perspective view of a window unit 100 in accordance with the invention. The window unit 100 includes a window frame 110. The window frame 110 defines a window frame perimeter 120. A window 130 is located within the frame perimeter 120. The window unit 100 can include a window frame 110 having an interior surface 115 (see FIGS. 1 and 2) and a window frame 210 having an exterior surface 215 (see FIGS. 3 and 4). The window frame 110 may include a sash frame, a casement frame or a frame surrounding window glass or sash frame or casement frame.

The window frame 110 may include two pair of opposing frame members. A first pair of opposing frame members includes a bottom frame member 111 and a top frame member 112 can be oriented along a horizontal rigid frame axis. A second pair of opposing rigid frame members includes a first side frame member 113 and a second side frame member 114 can be oriented along a vertical frame axis. The four frame members 111, 112, 113, 114 can generally form a square or rectangle shape. However, the window frame may be any shape.

The window unit 100 may be, for example, an opening in a wall or building for admission of light and air that may be closed by casements or sashes containing transparent, translucent or opaque material and may be capable of being opened or closed, such as, for example, a picture window, a bay window, a double-hung window, a skylight, egress window, an awning window, a casement window, a gliding window, and the like.

The window 110 can include illumination elements 141, 146, 150, 160. Window hardware 140, 145 can be disposed on the window 130. Window hardware 140, 145 may include, for example, locks, handles, knobs, and the like. The window hardware 140, 145 can have a window hardware illumination element 141, 146 disposed thereon. Illumination elements 141, 146 may include, for example, light emitting diodes, liquid crystal displays, electro luminescent strips, and the like.

A frame perimeter illumination element 150 can be disposed on a portion of, or the entire the frame perimeter 120. A lower illumination element 160 can be located along a bottom frame member 111 of the window frame 110. Illumination elements may include, for example, light emitting diodes, liquid crystal displays, electro luminescent strips, and the like.

The frame perimeter illumination element 150, lower illumination element 160 and window hardware illumination element 141, 146 may blend with the window unit 100, such that the frame perimeter illumination element 150, lower illumination element 160 and window hardware illumination element 141, 146 are not readily observable. The frame illumination element 150, lower illumination element 160 and window hardware illumination element 141, 146 may be a transparent or translucent material or may match the color of the window unit 100, window frame 110 or window hardware 140, 145.

The frame perimeter illumination element 150, lower illumination element 160 and window hardware illumination element 141, 146 can be in electrical connection with an alarm system such as, for example, a household smoke/fire alarm system. The alarm system can provide an activating signal to illuminate the frame perimeter illumination element 150, lower illumination element 160 and window hardware illumination element 141, 146 and produce an illuminated visual indicator. The activating signal can be, for example, an electrical signal or a mechanical signal.

The alarm system may be part of a network of sensors and alarm devices or the alarm system may be a fire and/or smoke detector 170 adjacent the window unit 100. The fire and/or smoke detector 170 may be in electrical connection to a network of sensors and alarm devices or the fire and/or smoke detector 170 may act independently. The frame perimeter illumination element 150, lower illumination element 160 and window hardware illumination element 141, 146 may be in electrical connection with a battery or wired directly to an electrical system. If wired to an electrical system, the electrical system may include a backup battery so that electricity would continue to operate the frame perimeter illumination element 150, lower illumination element 160 and window hardware illumination element 141, 146 in a power outage event.

The window unit 100 may also include a light 180. The light 180 can be a strobe light, a halogen light, an incandescent light, and the like. The light 180 can produce an illuminated visual indicator. The light can be located anywhere on the window frame 110. The light 180 may be recessed within the window frame 110 or flush with a surface of the window frame 110 or extend beyond the window frame 110.

The light 180 may blend with the window unit 100, such that the light 180 are not readily observable. The light 180 may be a transparent or translucent material or may match the color of the window unit 100, window frame 110 or window hardware 140, 145.

The light 180 can be in electrical connection with an alarm system such as, for example, a household smoke/fire alarm system. The alarm system can provide an activating signal to illuminate the light 180 and produce an illuminated visual indicator. The activating signal can be, for example, an electrical signal.

The alarm system may be part of a network of sensors and alarm devices or the alarm system may be a fire and/or smoke detector 170 adjacent the window unit 100. The fire and/or smoke detector 170 may be in electrical connection to a network of sensors and alarm devices or the fire and/or smoke detector 170 may act independently. The light 180 may be in electrical connection with a battery or wired directly to an electrical system. If wired to an electrical system, the electrical system may include a backup battery so that electricity would continue to operate the light 180 in a power outage event.

The window unit may also include a speaker element 190. The speaker element 190 can produce an audible indicator in response to an activating signal. The audible alarm may use any number of different tones, including a buzzer, a gong-like tone, a beeping tone, a siren sound, or it could also utilize a recorded human voice. The recorded human voice could be a person giving pre-recorded instructions, or the user could customize it, so the pre-recorded voice is the sound of a child's parent giving them instructions to come toward the sound of the voice.

The speaker element 190 can be located anywhere on the window frame 110. The speaker element 190 may be recessed within the window frame 110 or flush with a surface of the window frame 110 or extend beyond the window frame 110. The speaker element may be adjacent to the window frame 110, such as adjacent to and below the bottom frame member 111.

The speaker element 190 may blend with the window unit 100, such that the speaker element 190 is not readily observable. The speaker element 190 may be a transparent or translucent material or may match the color of the window unit 100, window frame 110 or window hardware 140, 145.

The speaker element 190 can be in electrical connection with an alarm system such as, for example, a household smoke/fire alarm system. The alarm system can provide an activating signal to activate the speaker element 190 and produce an illuminated visual indicator. The activating signal can be, for example, an electrical signal.

The alarm system may be part of a network of sensors and alarm devices or the alarm system may be a fire and/or smoke detector 170 adjacent the window unit 100. The fire and/or smoke detector 170 may be in electrical connection to a network of sensors and alarm devices or the fire and/or smoke detector 170 may act independently. The speaker element 190 may be in electrical connection with a battery or wired directly to an electrical system. If wired to an electrical system, the electrical system may include a backup battery so that electricity would continue to operate the speaker element 190 in a power outage event.

FIG. 2 is a perspective view of the window shown in FIG. 1 responding to an activation signal. The frame perimeter illumination element 150, lower illumination element 160, window hardware illumination element 141, 146 and light 180 are shown in an activated state. The speaker element 190 is also shown in an activated state.

FIG. 3 is a perspective view of a window 200 installed in a structure in accordance with the invention. The window 200 may be installed in an opening in siding 201 of a structure 202. The window unit 200 includes a window frame 210. The window frame 210 defines a window frame perimeter 220. A window 230 is located within the frame perimeter 220.

The window frame 210 may include two pair of opposing frame members. A first pair of opposing frame members includes a bottom frame member 211 and a top frame member 212 can be oriented along a horizontal rigid frame axis. A second pair of opposing rigid frame members includes a first side frame member 213 and a second side frame member 214 can be oriented along a vertical frame axis. The four frame members 211, 212, 213, 214 can generally form a square or rectangle shape. However, the window frame may be any shape.

The window unit 200 may be, for example, an opening in a wall or building for admission of light and air that may be closed by casements or sashes containing transparent, translucent or opaque material and may be capable of being opened or closed, such as, for example, a picture window, a bay window, a double-hung window, a skylight, egress window, an awning window, a casement window, a gliding window, and the like.

The window 210 can include illumination elements 241, 250. A frame perimeter illumination element 250 can be disposed on a portion of, or the entire the frame perimeter 220. Illumination elements may include, for example, light emitting diodes, liquid crystal displays, electro luminescent strips, and the like.

The frame perimeter illumination element 250 may blend with the window unit 200, such that the frame perimeter illumination element 250 is not readily observable. The frame illumination element 250 may be a transparent or translucent material or may match the color of the window unit 200 or window frame 210.

The frame perimeter illumination element 250 can be in electrical connection with an alarm system such as, for example, a household smoke/fire alarm system. The alarm system can provide an activating signal to illuminate the frame perimeter illumination element 250 and produce an illuminated visual indicator. The activating signal can be, for example, an electrical signal.

The alarm system may be part of a network of sensors and alarm devices or the alarm system may be a fire and/or smoke detector 170 (see FIG. 1 and 2) adjacent the window unit 200. The fire and/or smoke detector 170 may be in electrical connection to a network of sensors and alarm devices or the fire and/or smoke detector 170 may act independently. The frame perimeter illumination element 250 may be in electrical connection with a battery or wired directly to an electrical system. If wired to an electrical system, the electrical system may include a backup battery so that electricity would continue to operate the frame perimeter illumination element 250 in a power outage event.

The window unit 200 may also include a light 280. The light 280 can be a strobe light, a halogen light, an incandescent light, and the like. The light 280 can produce an illuminated visual indicator. The light can be located anywhere on the window frame 210. The light 280 may be recessed within the window frame 210 or flush with a surface of the window frame 210 or extend beyond the window frame 210.

The light 280 may blend with the window unit 200, such that the light 280 are not readily observable. The light 280 may be a transparent or translucent material or may match the color of the window unit 200, window frame 210 or window hardware 240, 245.

The light 280 can be in electrical connection with an alarm system such as, for example, a household smoke/fire alarm system. The alarm system can provide an activating signal to illuminate the light 280 and produce an illuminated visual indicator. The activating signal can be, for example, an electrical signal.

The alarm system may be part of a network of sensors and alarm devices or the alarm system may be a fire and/or smoke detector 170 (see FIGS. 1 and 2) adjacent the window unit 200. The fire and/or smoke detector 170 may be in electrical connection to a network of sensors and alarm devices or the fire and/or smoke detector 170 may act independently. The light 280 may be in electrical connection with a battery or wired directly to an electrical system. If wired to an electrical system, the electrical system may include a backup battery so that electricity would continue to operate the light 280 in a power outage event.

FIG. 4 is a perspective view of the window shown in FIG. 3 responding to an activation signal. The frame perimeter illumination element 250 and light 280 are shown in an activated state.

A window 100 may be constructed by providing a window frame 110 defining a frame perimeter 120 and providing a window 130 located within the frame perimeter 120. Window hardware 140, 145 may be disposed on the window 130, the window hardware 140, 145 may include a window hardware illumination element 141, 146. A frame perimeter illumination element 150 may be disposed on the frame perimeter 120. The window hardware illumination element 141, 146 and frame perimeter illumination element 150 produce an illuminated visual indicator in response to an activating signal.

We claim:

1. A window unit comprising:
(a) a window frame defining a frame perimeter;
(b) a window located within the frame perimeter; and
(c) a window illumination element disposed on the window frame;
wherein, the window illumination element produce an illuminated visual indicator in response to an activating signal.

2. The window unit of claim 1 wherein, the window illumination element being disposed on the window frame.

3. The window unit of claim 1 further comprising, window hardware disposed on the window frame, the window hardware having the window illumination element.

4. The window unit of claim 3 wherein, the window illumination element being disposed on the window frame.

5. The window unit of claim 3 wherein, the window illumination element being disposed on the window frame perimeter.

6. The window unit of claim 1 wherein, the window illumination element being electro luminescent strips.

7. The window unit of claim 2 wherein, the illumination element being electro luminescent strips.

8. The window unit of claim 3 wherein, the illumination element being electro luminescent strips.

9. The window unit of claim 4 wherein, the illumination element being electro luminescent strips.

10. The window unit of claim 5 wherein, the illumination element is disposed on the entire frame perimeter.

11. The window unit of claim 1 further comprising, a lower illumination element located along a bottom frame member of the window frame.

12. The window unit of claim 4 wherein, the lower illumination element being electro luminescent strips.

13. The window unit of claim 1 further comprising, a speaker element, disposed on or adjacent to the window frame, to produce an audible indicator in response to the activating signal.

14. The window unit of claim 13 wherein, the speaker element is adjacent to a bottom frame member of the window frame.

15. The window unit of claim 1 further comprising, a light disposed on the window frame to produce an illuminated visual indicator in response to the activating signal.

16. The window unit of claim 15 wherein, the light is a strobe light.

17. The window unit of claim 1 wherein, the window frame has an exterior surface defining an exterior frame perimeter and an interior surface defining an interior frame perimeter.

18. The window unit of claim 17 wherein, the illumination element is disposed on the interior frame perimeter.

19. The window unit of claim 17 wherein, the illumination element is disposed on the exterior frame perimeter.

20. The window unit of claim 17 wherein, the illumination element is disposed on the interior frame perimeter and exterior frame perimeter.

21. The window unit of claim 17 further including, a light disposed in the window frame interior surface to produce an illuminated visual indicator in response to the activating signal.

22. The window unit of claim 17 further including, a light disposed in the window frame exterior surface to produce an illuminated visual indicator in response to the activating signal.

23. The window unit of claim 17 further including, a light disposed on the window frame exterior surface and the window frame interior surface to produce an illuminated visual indicator in response to the activating signal.

24. The window unit of claim 21 wherein, the light is a strobe light.

25. The window unit of claim 22 wherein, the light is a strobe light.

26. The window unit of claim 23 wherein, the light is a strobe light.

27. A method comprising:
(a) providing a window frame defining a frame perimeter;
(b) providing a window within the frame perimeter;
(c) a window illumination element disposed on the window frame;
wherein, the window illumination element produce an illuminated visual indicator in response to an activating signal.
